(19) United States
(12) Patent Application Publication
(10) Pub. No.: US 2011/0127091 A1
(43) Pub. Date: Jun. 2, 2011

(54) Planar Beam Load Cell Assembly

(76) Inventors: Robin SHEPHERDSON, Beaconsfield (CA); Paul Shepherdson, Pointe Claire (CA)

(21) Appl. No.: 12/626,796

(22) Filed: Nov. 27, 2009

(51) Int. Cl. G01G 3/14

(52) U.S. Cl. 177/211; 177/225

(57) ABSTRACT

The present invention provides a weighing assembly comprising a planar beam load cell. The planar beam load cell assembly comprises means to prevent the damage of the planar beam load cell due to an overload. The device senses the load or force applied to its load receiving element with a high degree of accuracy. An arrangement of three or four of these devices can be used to support a platform or any suitable assembly onto which items can be placed, the purpose being to measure the weight of the items so placed. The planar beam load cell assembly may be retrofitted into existing scale assemblies. The planar beam load cell may further comprise means to prevent the damage of the planar beam load cell due to off-axis charges.

### CROSS-REFERENCE TO RELATED APPLICATIONS

There are no cross-related applications.

### FIELD OF THE INVENTION

The present invention generally relates to weighing apparatus employing load cells, and more particularly to weighing apparatus resistant to off-axis forces produced by off-center loading and having means to prevent the damage of the load cell due to an overload.

### BACKGROUND OF THE INVENTION

It is well known to use load cells to sense loads. Some conventional load cells include a block (also known as a load beam) and one or more strain gages mounted to the block. Deflection of the block due to an applied load changes the shape of the strain gages resulting in a change in the resistance of the strain gages. Generally, a known input voltage is applied to the strain gages and an output signal from the strain gages varies as the resistance of the strain gages vary to provide a signal indicative of the load applied to the load cell. Some conventional load cells include other types of sensors, such as optical sensors and capacitive sensors, rather than strain gages, that measure the size of gaps between elements of a load cell system. It is desirable, of course, for load cells to sense applied loads with a high degree of accuracy and repeatability.

There is a need to provide a load cell assembly having means to protect the load cell from overload and from off-axis charges.

### SUMMARY OF THE INVENTION

The aforesaid and other objectives of the present invention are realized by generally providing a planar beam load cell assembly comprising a housing comprising a substantially horizontal base and at least two sides extending upwardly from the base; a planar beam load cell comprising a mounting hole, the planar beam load cell being connected to the housing; a load transmitting part having an upper extremity and a lower extremity, the load transmitting part extending through the mounting hole of the planar beam load cell and wherein there is a gap between the base and the lower extremity of the load transmitting part in an uncharged condition and wherein the lower extremity of the load transmitting part contacts the base in an overload condition; a load receiving element, the load receiving element being located at the upper extremity of the load transmitting part; a guide mounted on the load transmitting part, the guide extending between the load receiving element and the planar beam load cell; and a spring assembly mounted on the load transmitting part, the spring assembly extending between the guide and the planar beam load cell wherein the load receiving element transmits the charge of a weight to the planar beam load cell through the load transmitting part and the guide.

In a preferred embodiment, the load transmitting part is a screw connected through the mounting hole to the planar beam load cell. The screw is preferably installed so that its head will contact the base in an overload condition.

The spring is preferably composed by a plurality of Belleville washers, the spring being pre-loaded to a load value exceeding the full load capacity of the planar beam load cell but less than the rated overload limit of the planar beam load cell.

In a preferred embodiment, the planar beam load cell assembly further comprises an overload plate located between the load receiving element and the guide, wherein the overload plate extends over the sides of the housing. There is a gap between the sides and the overload plate in an uncharged condition and the overload plate contacts the sides in an overload condition or off-axis overload. The overload plate may further comprise an extension preventing the overload plate to rotate horizontally.

In a further preferred embodiment, the load receiving element is a loading button, preferably made from a resilient material such as rubber.

The load cell according to the present invention preferably includes a beam or plate having strain gages mounted on opposite lateral edges of the plate and a slot or opening in the plate extending between laterally opposite strain gages. The load cell is thus “planar” in form. It may be dimensioned in the lateral direction to provide much better resistance to torsional forces than known single beam load cells while functioning well as a load cell in other respects.

The preload of the spring assembly is chosen so as to provide correct gap (distance between the head of the screw and the base or between the overload plate and the sides of the housing) for the correct amount of overload protection.

The features of the present invention which are believed to be novel are set forth with particularity in the appended claims.

### BRIEF DESCRIPTION OF THE DRAWINGS

The above and other objects, features and advantages of the invention will become more readily apparent from the following description, reference being made to the accompanying drawings in which:

FIG. 1 is an isometric view of an embodiment of the planar beam load cell assembly according to the present invention.

FIG. 2 is a top view of the planar beam load cell assembly of FIG. 1.

FIG. 3 is a side view of the planar beam load cell assembly of FIG. 1.

FIG. 4 is an exploded view of the planar beam load cell assembly of FIG. 1.

FIG. 5 is a cross-section view of the planar beam load cell assembly of FIG. 1 along A-A.

FIG. 6 is a cross-section view of the planar beam load cell assembly of FIG. 1 along B-B.

### DETAILED DESCRIPTION OF THE PREFERRED EMBODIMENT

A novel planar beam load cell assembly will be described hereinafter. Although the invention is described in terms of specific illustrative embodiment(s), it is to be understood that the embodiment(s) described herein are by way of example only and that the scope of the invention is not intended to be limited thereby.

The planar beam load cell assembly 100 is a device for general purpose weighing applications. The device senses the load or force applied with a high degree of accuracy. An arrangement of three or four of these devices can be used to support a platform or any suitable assembly onto which items can be placed, the purpose being to measure the weight of the items so placed.

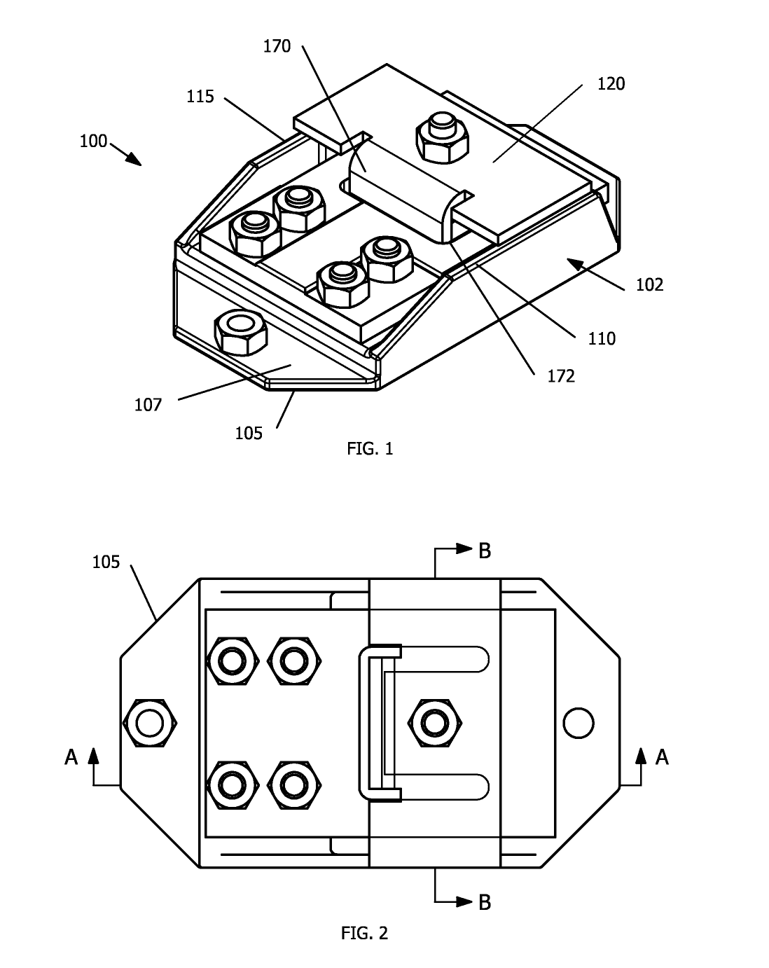

As shown in FIGS. 1 to 6, the planar beam load cell assembly 100 comprises a housing 102 comprising a substantially horizontal base 105 and sides 110 and 115 extending substantially perpendicularly from the base 105. A planar beam load cell 125 is mounted by screws 150 on the housing 102. The charge of a weight is transmitted to the planar beam load cell 125 through a spring assembly 130 and guide part 135 which is held in position by a load transmitting part 140, preferably a screw, inserted from below the load cell 125. The spring assembly 130 is pre-loaded to a load value exceeding the full load capacity of the planar beam load cell 125 but less than the rated overload limit of the planar beam load cell 125. Hence, as load 180 increases past the rated load, the spring 130 will compress and the screw 140 will descend inside the guide 135 until either the screw head 142 contacts the upper surface 107 of the base 105 or until an overload plate 120 contacts both sides 110 and 115 of the housing 102, at which load the downward motion will stop. This prevents further load from reaching the planar beam load cell 125 and saves it from potential damage as a result. The overload plate 120 is prevented from rotating, but is free to move vertically without affecting the accuracy of the device, by means of an extension or downturn 170 or pins (not shown) that can contact the load sensitive part of the planar beam load cell 125.

The spring 130 is preferably composed by a plurality of Belleville springs also known as cupped spring washer or Belleville washer. It has a slight conical shape which gives the washer a spring characteristic. The spring 130 is extending between the planar beam load cell 125 and the overload plate 120. It has to be understood however that another type of spring may be used with the planar beam load cell assembly without departing from the present invention.

FIGS. 1 and 2 show one possible method for preventing rotation of the horizontal overload plate 120. The downturn 170, which is partially inserted through an opening 172 of the planar beam load cell 125, prevents the overload plate to rotate horizontally. Pins placed appropriately may also be used to serve this function. The pins may be inserted into appropriate openings in the planar beam load cell 125 or of the housing 102.

The sensing element is a planar beam load cell 125, being manufactured separately and used as part of the planar beam load cell assembly 100. The planar beam load cell 125 is mounted on the housing 102 which provides the rigid mounting surface necessary for high accuracy as well as protection from surrounding influences. The vertical spring assembly 130 is preferably (but not necessarily) made from a stack of several Schnorr disc springs or “Belleville Washers”. The Belleville Washers are aligned by means of a guide 135 threaded through the spring assembly 130. The screw 140 is inserted into the mounting hole 127 and into the guide 135. The guide 135 is preferably a shoulder washer made from nylon or other suitable material. From below the planar beam load cell 125, the screw 140 is inserted such that it extends beyond the top of the guide 135 and allows its insertion into a nut 145 or flat top plate (or loading button) 147. The loading button or element 147 is preferably assembled onto the top of the spring assembly 130 described above in such a way that the platform or weighing assembly is supported but some lateral motion is allowed, which is necessary for proper operation and accuracy of measurement. Thus, as weight is applied to the platform or weighed assembly attached to the loading button 145, the force is measured by the planar beam load cell 125, creating an electrical signal that can be combined with the signals from the other planar beam load cell assembly supporting this same structure and used to create a weight display on a digital weight indicator or similar external device.

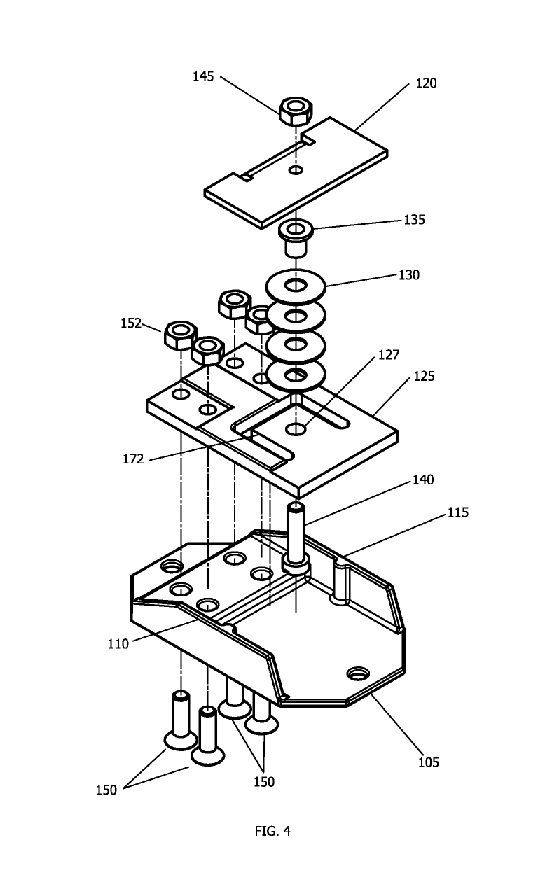

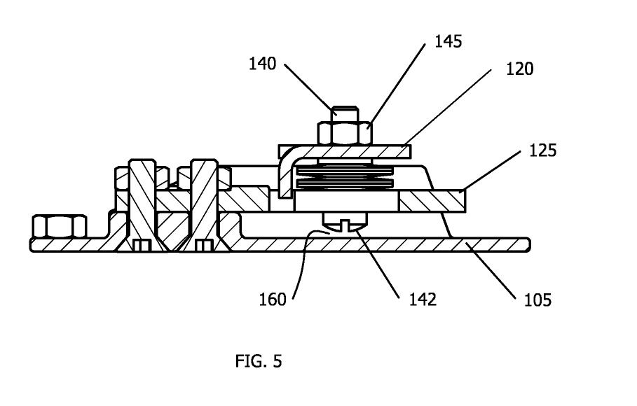

FIG. 5 shows the planar beam load cell assembly with no load or preload applied on it, the spring 130 is thus in an uncompressed state. There is a gap 160 between the surface 107 of the base 105 and the head 142 of the screw 140.

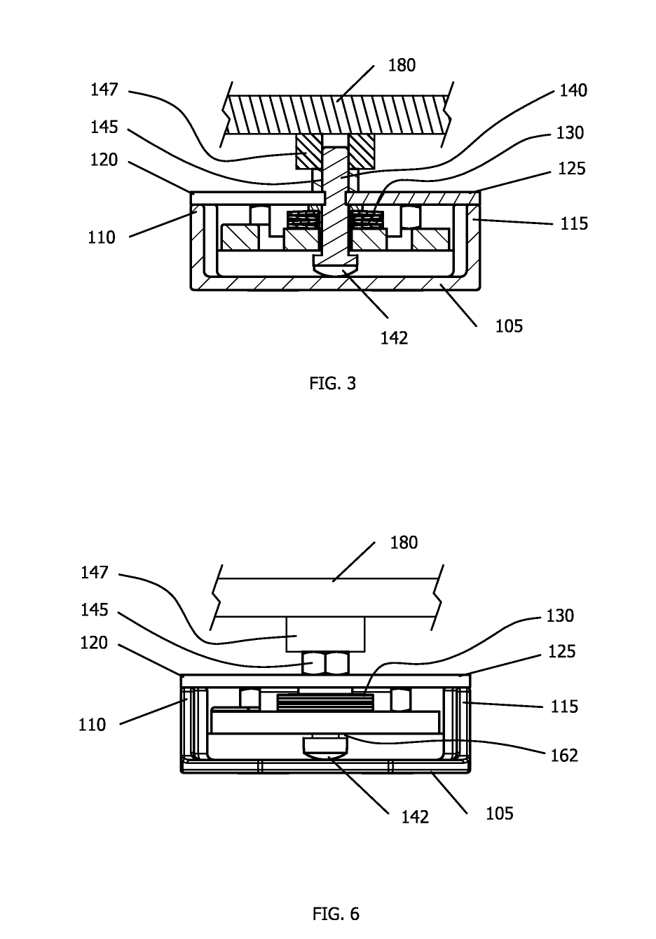

FIGS. 3 and 6 show the planar beam load cell assembly in an overload condition. When excessive pressure is applied through the loading button 147 to the top of the screw 140, the spring assembly 130 is compressed, allowing the gap 160 between the head 142 of the screw 140 and the upper surface 107 of the base 105 to close. The excess force is thus taken up by the base 105, which protects the planar beam load cell 125 from any additional force. The downward movement of the screw 140 due to the overload creates a gap 162 between the planar beam load cell 125 and the head 142 of the screw 140. The overload plate 120, if used, has dimensions that allow it to overlap the sides 110 and 115 of the housing 102 in such a way that when an off-axis force or off-axis overload is applied to the loading button (or load receiving element) 147, causing the overload plate 120 to tilt to one side, the gaps between the overload plate 120 and the sides 110 and 115 of the housing 102 close, protecting the planar beam load cell 125 from excessive off-axis forces. This latter protection may be omitted to reduce cost, in which case the screw 140 is inserted into a nut or simply into the loading button 147.

A planar beam load cell is a load sensing device fabricated from a flat piece of suitable metal with cut-outs inserted so as to form parallel beam structures. When a force is applied to the appropriate point in the axis at right angles to the flat metal structure, stresses are created in the two parallel beams. Strain gauges bonded to these beams form a measurement circuit that senses the changes in stress and hence measure the force applied to the planar beam load cell.

The loading button 147 may be a commercially available rubber “vibration mount” with an appropriate female threaded side that allows its assembly onto the screw 140 and an appropriate male or female thread that allows attachment of the platform or other device (not shown) to its upper surface. Alternatively it may be a rubber appliance foot with raised sides and a well in the center with a hole that allows the screw 140 to extend through for fixing. Various other loading buttons may be used for different applications and these in no way change the operation or general utility of the device.

The housing is preferably made of aluminum (cast aluminum), and the overload plate is preferably made from steel. However, it is understood that the part of the planar beam load cell assembly can be made of other material such as steel, composite or other metal or metal alloys without departing from the present invention.

While illustrative and presently preferred embodiment(s) of the invention have been described in detail hereinabove, it is to be understood that the inventive concepts may be otherwise variously embodied and employed and that the appended claims are intended to be construed to include such variations except insofar as limited by the prior art.

1) A planar beam load cell assembly comprising:
a) a housing (102) comprising a substantially horizontal base (105) and at least two sides (110, 115) extending upwardly from said base (105);
b) a planar beam load cell (125) comprising a mounting hole (127), said planar beam load cell (125) being connected to said housing (102);
c) a load transmitting part (140) having an upper extremity and a lower extremity (142), said load transmitting part (140) extending through said mounting hole (127) of said planar beam load cell (125) and wherein there is a gap between said base (105) and said lower extremity of said load transmitting part (140) in an uncharged condition and wherein said lower extremity (142) of said load transmitting part (140) contacts said base (105) in an overload condition;
d) a load receiving element (147), said load receiving element (147) being located at said upper extremity of said load transmitting part (140);
e) a guide (135) mounted on said load transmitting part (140), said guide (135) extending between said load receiving element (147) and said planar beam load cell (125); and
f) a spring assembly (130) mounted on said load transmitting part (140), said spring assembly (130) extending between said guide (135) and said planar beam load cell (125);
wherein said load receiving element (147) transmits the charge 180 of a weight to said planar beam load cell (125) through said load transmitting part (140) and said guide (135).

2) The planar beam load cell assembly of claim 1, further comprising an overload plate (120) located between said load receiving element (147) and said guide (135), and wherein said overload plate (120) extends over said sides (110, 115) of said housing (102), wherein there is a gap between said sides (110, 115) and said overload plate (120) in an uncharged condition and wherein said overload plate (120) contacts said sides (110, 115) in an overload condition.

3) The planar beam load cell assembly of claim 1, wherein said spring assembly (130) is pre-loaded to a load value exceeding the full load capacity of said planar beam load cell (125) but less than the rated overload limit of said planar beam load cell (125).

4) The planar beam load cell assembly of claim 1, wherein said load transmitting part (140) is a screw.

5) The planar beam load cell assembly of claim 1, wherein said loading receiving element (147) is made from a resilient material.

6) The planar beam load cell assembly of claim 2, wherein said overload plate (120) further comprises an extension (170) preventing said overload plate (120) to rotate horizontally.

7) The planar beam load cell assembly of claim 1, wherein said spring (130) comprises a plurality of Belleville washers.
